(19) United States
(12) Patent Application Publication
(10) Pub. No.: US 2026/0099601 A1
(43) Pub. Date: Apr. 9, 2026

(54) AUTONOMOUS THREAT OPERATION SYSTEM

(71) Applicant: Simbian, Inc., Mountain View, CA (US)

(72) Inventors: Ambuj Kumar, Sunnyvale, CA (US); Alankrit Chona, Redwood City, CA (US); Sumedh Barde, Sammamish, WA (US); Prince Saroj, Bengaluru (IN); Vedang Karwa, Jodhpur (IN)

(73) Assignee: Simbian, Inc., Mountain View, CA (US)

(21) Appl. No.: 18/909,240

(22) Filed: Oct. 8, 2024

(51) Int. Cl. G06F 21/56; G06F 21/55

(52) U.S. Cl. CPC G06F 21/566; G06F 21/554

(57) ABSTRACT

A system to automate threat operations is disclosed. The system may include a processor and a memory. The processor may obtain an unstructured data from one or more external sources, and convert the unstructured data into a structured data by using a first Large Language Model (LLM). The processor may execute a threat hunt model to detect a threat to a computing infrastructure of an organization based on the structured data by using an agentic threat detection and response module. The agentic threat detection and response module includes one or more second LLMs. The processor may dynamically detect the threat based on the execution of the threat hunt model by using the agentic threat detection and response module, and automatically perform an action responsive to detecting the threat by using the agentic threat detection and response module.

### FIELD

The present disclosure relates to cyber security, and more particularly to systems and methods for performing investigating and remediating cyber threats (“threat operations”) autonomously.

### BACKGROUND

In the cybersecurity industry, Security Operations (SecOps) team or security analysts typically work on identifying and fixing problems or threats in computing systems. For example, a security analyst may analyze risks, vulnerabilities, threats, and incidents related to the networked computing systems and/or cybersecurity systems in general.

In some scenarios, the security analysts go through different threat advisories, blogs, social media posts, and documents (“threat content”) and determine if the threat content is relevant for the organization. When the security analysts find that the content is relevant for the organization, the security analysts need to operationalize threat intelligence, which includes determining if the organization is merely susceptible or has been affected by the threat as well as mitigating the risk caused by the threat. Thus, the traditional SecOps workflow involves substantial manual effort to integrate and operationalize threat intelligence, which often results in delayed responses and increased vulnerability to cyber threats. The complexity of manually sifting through vast amounts of data to detect and mitigate threats poses significant challenges to timely and effective cybersecurity measures.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example system to automate threat operations in accordance with the present disclosure.

FIG. 2 depicts an example process to automate threat operations in accordance with the present disclosure.

FIG. 3 depicts a flow diagram of a first method to perform hypothesis-based threat hunting in accordance with the present disclosure.

FIG. 4 depicts a flow diagram of a second method to perform threat operations in accordance with the present disclosure.

### DETAILED DESCRIPTION

### Overview

The present disclosure describes a system and method to autonomously perform cyber threat operations. Specifically, the system may autonomously collect, analyze, and operationalize threat intelligence, thereby enhancing the system efficiency and effectiveness of threat detection and response. The system utilizes agentic Large Language Models (LLMs) to dynamically orchestrate and automate the processes involved in threat detection and response.

In some aspects, the system may integrate with a plurality of external sources that may provide threat intelligence feed or threat content (e.g., threat advisories, blogs, documents, etc.) to the system. The system may continuously collect the threat intelligence feed. The feed may contain both structured and unstructured information about the potential indicators of compromises (IOC), tactics, techniques, and procedures (TTP), target persona of the threat actors (for example, some actors may only be interested in hospitals in a specific country), modus operandi of the threat actors (for example, the actor may first do an email phishing campaign in unrelated operation to gauge the sophistication of security defense before operationalizing actual attack with account takeover using SIM swap attacks), and the methods to recover from the attack (for example, the security researcher publishing advisory may have some recover recommendation or Security orchestration, automation and response I (SOAR) playbooks). Responsive to obtaining the threat intelligence feed, the system may automatically parse and convert the threat intelligence feed (that may be in the form of an unstructured data having threat content) into a multitude of structured data actionable for various security tools. The structured data may be in the form of a knowledge graph that may be in Structured Threat Information eXpression (STIX) format. In an exemplary aspect, the system may convert the unstructured data in STIX 2.x (JSON) format, which may assist the system to efficiently identify and mitigate threat. By using the STIX format and the agentic LLMs, the system dynamically orchestrates and automates the processes involved in threat detection and response. In some aspects, the system may determine relevance of the threat intelligence feed or threat content using the extracted data from the threat content, and may use the threat intelligence feed to detect the threat when the threat intelligence feed or threat content may be relevant for the user/organization for which the system is performing the cyber threat operation. In some aspects, the system may utilize LLMs to determine whether the threat intelligence feed or threat content is relevant for the organization. For example, the system may determine that the threat may be relevant if the industry indicated in the threat intelligence feed is similar to the user/organization's industry. In some aspects, the system may utilize the information from the threat content with the organization's historic actions to determine next steps. For example, the system may determine to update an existing SOAR playbook and execute it.

Responsive to converting the unstructured data into the structured data, the system may autonomously execute a threat hunt model to detect a threat in the organization's computing infrastructure. In some aspects, the system may select a threat hunt model, from a plurality of threat hunt models, based on the structured data. Responsive to selecting the threat hunt model, the system may execute the threat hunt model based on the structured data. For instance, the system may use the IP address indicated in the structured data to execute the threat hunt model. Based on the execution of the threat hunt model, the system may dynamically detect the threat and perform actions accordingly. The actions may include actions to respond, resolve, and mitigate the detected threat(s).

In some aspects, the system may utilize the agentic LLMs to dynamically orchestrate and automate the processes involved in threat detection and response. Specifically, the system utilizes the agentic LLM(s) to generate threat hunt queries automatically to perform threat hunting exercises. In addition, the system may maintain a comprehensive view of organization's assets (internal and external assets) by integrating internal and external asset data, and normalize the asset view to form a normalized organization data. Further, the system may maintain a comprehensive view of a data log associated with the organization's computing infrastructure and may normalize the data log to form a normalized data log. Further, the system may maintain a comprehensive view of non-security tools such as emails and instant messages (like Microsoft Teams, Slack). The system agentic LLM may access the normalized organization data and the normalized data log, via a normalized action space and a normalized log space respectively, to execute the threat hunt model. The system leverages a sophisticated arrangement of the normalized log space and the normalized action space to allow agentic LLMs to dynamically access, analyze, and respond to threats using the threat hunt queries, thus eliminating the need for manual data handling and reducing the response times significantly.

The present disclosure discloses an autonomous, federated cybersecurity system designed to streamline the operational tasks typically performed by Security Operations (SecOps) teams. The system significantly reduces the manual labor typically required by the SecOps teams to operationalize threat intelligence and conduct threat hunting exercises. By automating the integration, analysis, and operationalization of threat intelligence, the system enhances the efficiency and effectiveness of threat detection and response.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

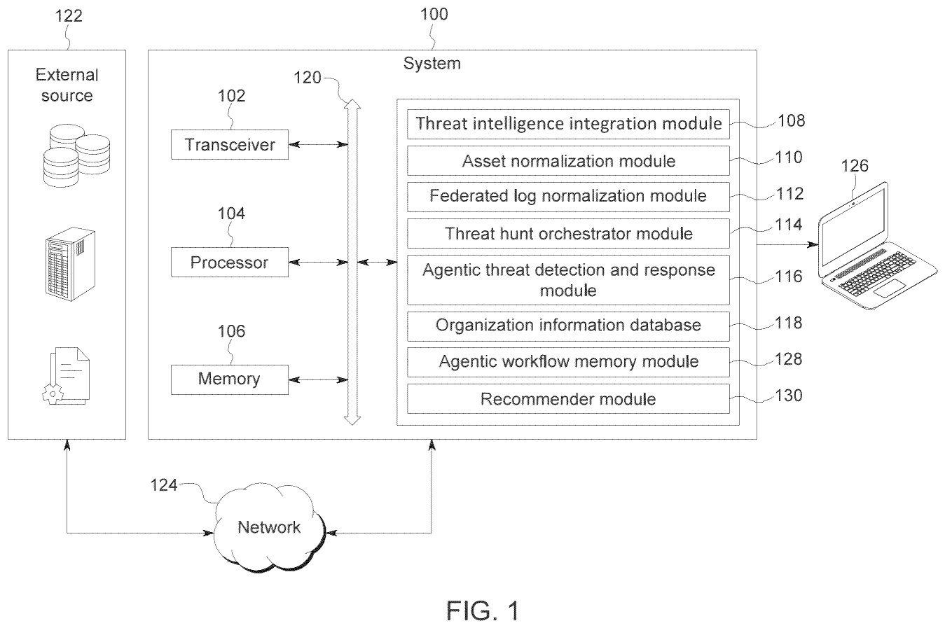

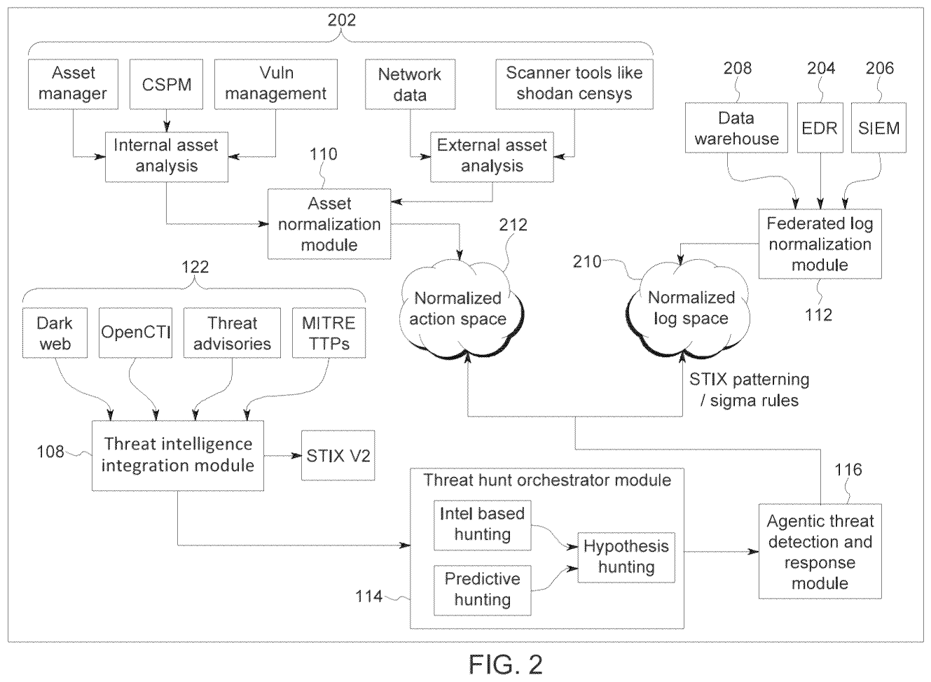

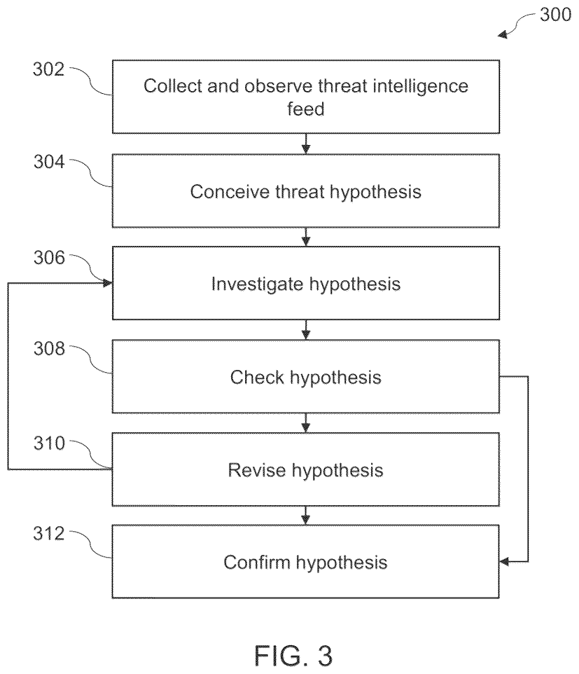

FIG. 1 depicts an example system 100 to automate threat operations in accordance with the present disclosure. While explaining FIG. 1, references will be made to FIGS. 2 and 3.

The system 100 may be hosted on a server or a distributed computing system, and perform threat operations automatically. Specifically, the system 100 may perform automatic analysis of threat documents or threat content (e.g., threat advisories, blogs etc.), and may automatically operationalize the threat documents to identify and address the threats, which includes determining if the organization is merely susceptible or has been affected by the threat as well as mitigating the risk caused by the threat. The system 100 may include agentic Artificial Intelligence (AI) or agentic Large Language Models (LLMs), which may enable automatic system operation. The components and functions of the system 100 are described below.

The system 100 may include a plurality of components including, but not limited to, a transceiver 102, a processor 104 (or one or more processors), a memory 106, a threat intelligence integration module 108, an asset normalization module 110, a federated log normalization module 112, a threat hunt orchestrator module 114, an agentic threat detection and response module 116, an organization information database 118, and/or the like, which may communicatively couple with each other via a data bus 120. As described above, the system 100 may be hosted on a server or a distributed computing system, which may communicatively couple with a plurality of external sources 122.

The external source 122 may include, but are not limited to, a Dark Web network, an open cyber threat intelligence (OpenCTI) platform, threat advisories or documents, customer subscribed premium threat intel, and/or the like. The system 100 may receive thread intelligence feed/data from the external source 122. The thread intelligence feed/data may be a stream of external data or information that may enable the system 100 to identify or detect threat in a computing infrastructure or system of an organization (e.g., a company, an institution, an association, a government body, etc.). In some aspects, the thread intelligence feed may include real-time or near-real-time insights into emerging attacks, which may include IP addresses, domain names, and file hashes, as well as information on the tactics, techniques, and procedures (TTPs) used by threat actors. In some aspects, the external source 122 may include a platform that stores security framework. In an exemplary aspect, the security framework may include ATT&CK (Adversarial Tactics, Techniques, and Common Knowledge) framework. The ATT&CK framework may be a knowledge base and model for cyber adversary behavior, reflecting the various phases of an adversary's attack lifecycle and the platforms they are known to target. The system 100 may use the framework to develop threat models and methodologies to mitigate the threats.

In some aspects, the system 100 may communicatively couple with the external source 122 by using one or more networks 124. The network(s) 124, as described here, illustrates an example communication infrastructure in which the connected devices discussed in various embodiments of this disclosure may communicate. The network may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In addition, the system 100 may communicatively couple with a user device 126 associated with a user, via the network 124. In some aspects, the system 100 may be hosted on the user device 126. The user device 126 may include, for example, a mobile phone, a laptop, a computer, a tablet, a wearable device, or any other device with communication capabilities.

The transceiver 102 may transmit/receive information/data to/from external systems and devices, via the network 124. In some aspects, the transceiver 102 may receive the threat intelligence feed from the external source 122. In further aspects, the transceiver 102 may receive inputs/instructions/threat intelligence feed or documents from the user device 126, via a user interface rendered on the user device 126. The transceiver 102 may further receive user inputs/prompts (e.g., user query) in natural language from the user device 126, which enables the user to easily interact with the system 100 in natural language. In alternative aspects, the user query may not be in natural language, and may instead include or be in the form of an image, a document, speech, and/or the like. In further aspects, the transceiver 102 may transmit a notification or an alert to the user device 126. Furthermore, the transceiver 102 may transmit a response to the user prompt (e.g., a response to the user's query in natural language) to the user device 126.

The processor 104 may utilize the memory 106 to store programs in code and/or to store data for performing aspects in accordance with the disclosure. The memory 106 may be a non-transitory computer-readable storage medium or memory storing a program code that enables the processor 104 to perform operations in accordance with the present disclosure. The memory 106 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 106 may store the modules described above, e.g., the threat intelligence integration module 108, the asset normalization module 110, the federated log normalization module 112, the threat hunt orchestrator module 114 and the agentic threat detection and response module 116. Stated another way, in some aspects, these modules may be part of the memory 106. In alternative aspects, one or more modules described above may be stored outside the memory 106, as shown in FIG. 1. The modules may include instructions which the processor 104 may implement to perform respective tasks. In some aspects, one or more modules may use large language models (LLM) or agentic LLMs to perform their respective tasks. The details of these modules are described later in the description below.

In some aspects, the processor 104 may obtain the threat intelligence feed/data via the threat intelligence integration module 108 and the transceiver 102. In some aspects, the processor 104 may obtain the threat intelligence feed/data automatically from the external source 122, or may obtain the threat intelligence feed/data from the user device 126. As described above, the threat intelligence feed may include unstructured data having threat content including real-time or near-real-time insights into emerging attacks, which may include IP addresses, domain names and file hashes, as well as information on the tactics, techniques, and procedures (TTPs) used by threat actors. The processor 104 may collect the unstructured data (or the threat intelligence feed) continuously or at a predefined frequency or as and when the threat intelligence feed/data is available from the external source 122.

Responsive to obtaining the unstructured data from the external source 122, the processor 104 may automatically parse the unstructured data and convert it to structured data, via the threat intelligence integration module 108, which may enable the processor 104 to perform deep analysis of threat actors and potential threats. In some aspects, the threat intelligence integration module 108 may include a first LLM that may enable the processor 104 to convert the unstructured data into the structured data automatically, and store the structured data in the memory 106. In some aspects, the processor 104 may convert the unstructured data into Structured Threat Information eXpression (STIX) format. Stated another way, the structured data may be in STIX format. The STIX format facilitates assembling of different pieces of information in a structured and standardized manner. In an exemplary aspect, the processor 104 may convert the unstructured data in STIX 2.x (JSON) format, which may assist the processor 104 to efficiently identify and mitigate threat.

The structured data may be in the form of a knowledge graph that may provide relationship between different entities, which may be based on the STIX format. In some aspects, the knowledge graph may include nodes that represent IOCs and edges that represent IOC relations. The IOC may be evidence left behind by an attacker or malicious software that may be used to identify a security incident. The IOC may include network-based IOCs (e.g., malicious IP addresses, domains, or URLs), Host-based IOCs (e.g., file names or hashes, registry keys, or suspicious processes executing on the host), Behavioral IOCs (login patterns, network traffic patterns), etc. In some aspects, the knowledge graph may provide or extract IP addresses from the unstructured data, relate each IP address to a relevant TTP (e.g., using the security framework described above), and relate the TTP to the threat actor or actors that are known to use it, and to courses of action that can help mitigate its impact.

In further aspects, the processor 104 may analyze the unstructured data from the external source 122, and may determine whether the unstructured data or threat content is relevant for the user/organization (for which the system 100 may be performing the threat detection and mitigation operation), by using the threat intelligence integration module 108. In some aspects, the processor 104 may perform such determination by using the first LLM. The first LLM may be trained by using a training dataset that is restricted to a predefined dataset (e.g., organization information stored in the organization information database 118, which may be associated with the organization described above). In some aspects, the user (or end customer) may completely control the first LLM by restricting its knowledge to a curated set of documents and information set (which may be a part of the organization information). The user may select the curated set of documents and information set to train the first LLM. Stated another way, the processor 104 may confirm the relevancy of the unstructured data to the organization/user based on user preferences. In an exemplary aspect, the first LLM may continuously learn user engagement or organization domain, and the processor 104 may use the first LLM to determine whether the unstructured data may be relevant for the user/organization.

Responsive to a determination that the unstructured data is irrelevant for the organization, the processor 104 may discard the unstructured data. Stated another way, the processor 104 may not proceed with further processing of the unstructured data when the processor 104 determines that the unstructured data is not relevant to the organization. On the other hand, responsive to a determination that the unstructured data is relevant for the organization, the processor 104 may convert the unstructured data into the structured data, described above. In alternative aspects, the processor 104 may first convert the unstructured data into the structured data, and then may determine whether the structured data is relevant to the organization or not in a similar manner as described above. In this case, the processor 104 may store the structured data in the memory 106 responsive to a determination that the structured data is relevant to the organization. Further, the processor 104 may discard the structured data responsive to a determination that the structured data is irrelevant to the organization.

In further aspects, the processor 104 may coordinate threat hunt activities to identify threats within the organization's computing infrastructure based on the structured data, via the threat hunt orchestrator module 114. In some aspects, the processor 104 may select a threat hunting model, from a plurality of threat hunting models, to detect the threat to (or detect malicious anomalies in) the organization's computing infrastructure, via the threat hunt orchestrator module 114. The processor 140 may select the threat hunting model based on the structured data. Responsive to selecting the threat hunting model, the processor 104 may execute, via the threat hunt orchestrator module 114, the threat hunting model to detect the threat in the organization's computing infrastructure based on the structured data, by using the agentic threat detection and response module 116. In some aspects, the agentic threat detection and response module 116 may include one or more second LLMs to perform such operations automatically. In some aspects, the threat hunt orchestrator module 114 may utilize or use the agentic threat detection and response module 116 to automatically operationalize the structured data to detect the threat in the computing infrastructure of the organization. Since the agentic threat detection and response module 116 includes the second LLMs, it may be appreciated from the description above that the threat hunt orchestrator module 114 utilizes the second LLMs (via the agentic threat detection and response module 116) to automatically operationalize the structured data and detect the threat in the organization's computing infrastructure.

The plurality of threat hunting models described above may include, but is not limited to, an intel-based hunting, a predictive hunting, a hypothesis-based hunting, and/or the like. The intel-based hunting is a reactive hunting model that uses IOCs from the structured data (associated with the threat intelligence feed). The processor 104, via the threat hunt orchestrator module 114, may provide automatic alerts and integrate the IOCs into Security information and event management (SIEM) tool (that may provide insights and a track record of activities in the computing infrastructure) for immediate response. Once the SIEM has received the alert based on the IOCs, the processor 104 may investigate malicious activity before and after the alert to identify any compromise in the organization's computing environment.

The predictive hunting predictively formulates and tests hypotheses based on behavioral patterns and known attacker TTPs, aligned with the MITRE ATT&CK framework. The predictive hunting uses indicator of attack (IOA) and TTPs of attackers.

The hypothesis-based hunting model may be tailored to specific organization needs or situational awareness. This model adapts to unique security requirements or emerging scenarios. This technique involves forming a hypothesis about a potential threat based on current threat intelligence, industry trends, or vulnerabilities within the computing infrastructure, which may act as a starting point for further investigation. Custom or situational hunts may be based on customers'or user's requirements, or they may be proactively executed based on situations, such as geopolitical issues and targeted attacks. These hunting activities can draw on both intel and hypothesis-based hunting models using IOA and IOC information. An example hypothesis-based threat hunting method is described later in the description below in conjunction with FIG. 3.

The threat hunt orchestrator module 114 may utilize the agentic threat detection and response module 116 to execute the threat hunting model. Stated another way, the threat hunt orchestrator module 114 may spin-off a threat hunt orchestrator workflow to enable the agentic threat detection and response module 116 to effectively orchestrate and execute the threat hunting model. In some aspects, the agentic threat detection and response module 116 may utilize the second LLMs and operate in real-time, querying and analyzing data as needed from federated sources (e.g., organization assets and data log described later below) to execute the threat hunt model.

Responsive to executing the threat hunt model, the processor 104 may dynamically detect, via the threat hunt orchestrator module 114, the threat by using the agentic threat detection and response module 116. The processor 104 may detect the threat based on the threat hunt model. The processor 104 may further automatically perform, via the threat hunt orchestrator module 114, an action responsive to detecting the threat by using the agentic threat detection and response module 116. In some aspects, the agentic threat detection and response module 116 may utilize the output from the threat hunt orchestrator module 114 to dynamically detect and perform the action automatically.

The actions described above may include actions to respond, resolve, and mitigate the detected threat(s). For example, the actions may include, containment (e.g., block hash, block user), eradication (e.g., remove all malicious components from affected systems, including malware, compromised accounts, etc.), recovery (e.g., restoring altered or deleted files to their original state), post-review (e.g., analyze incident, enhance future threat hunting process), updating firewall /IPS rules, deploying security patches, changing system configurations, etc. In some aspects, the processor 104 may automatically execute the actions to mitigate the threats if they are present. In further aspects, the processor 104 may take user's approval (via the user device 126), and perform the action based on the user's approval.

In some aspects, to enable the threat hunt orchestrator module 114 to execute the threat hunt model, the processor 104 may access the organization's computing infrastructure (or organization assets) and obtain organization data associated with the computing infrastructure, via the asset normalization module 110 and by using the agentic threat detection and response module 116. The computing infrastructure may include internal and/or external assets 202 (shown in FIG. 2) associated with the organization. The asset normalization module 110 may integrate with the organization's computing infrastructure, perform internal asset and external asset analysis, and maintain a real-time, comprehensive view of organization assets by integrating internal and external asset data (specially crown jewels and the publicly exposed assets), and normalize the asset view to support several platforms and vendors all at the same time to form a normalized organization data. For instance, the asset normalization module 110 may work in tandem with Cloud Security Posture Management (CSPM), vulnerability management systems and asset managers to maintain up-to-date security posture assessments.

The processor 104 may access the internal and/or external assets, and integrate internal and external asset data, via the asset normalization module 110. In some aspects, the processor 104 may normalize the organization data to form the normalized organization data, via the asset normalization module 110, which may enable the system 100 to support several platforms at the same time. In some aspects, the processor 104 may store the normalized organization data in the memory 106 or the organization information database 118 (that may be a part of the memory 106 or may be outside the memory 106). The processor 104 may further use asset hunter workflows that collect more knowledge from people (Teams, Slack, Emails) to augment the normalized organization data.

In addition, to enable the threat hunt orchestrator module 114 to execute the threat hunt model, the processor 104 may obtain a data log associated with the organization's computing infrastructure, via the federated log normalization module 112 and by using the agentic threat detection and response module 116. The federated log normalization module 112 may maintain a comprehensive data catalogue or data log to make them queryable on demand in real-time, and may normalize the data log to form a normalized data log. In some aspects, the processor 104 may normalize the data log to form the normalized data log, via the federated log normalization module 112. In some aspects, the normalized data log may be associated with one or more of an Endpoint Detection and Response (EDR) tool 204, a Security information and event management (SIEM) tool 206, a customer specific data or data warehouse 208, or cloud security tool (to allow the user to add new sources of search, without changing the workflow since the second LLM generates the list of information sources based on the query and its relevance). The normalized data log may enable the processor 104 to perform arbitrarily complex log analysis to perform threat detection. In some aspects, the processor 104 may store the normalized data log in the memory 106 or the organization information database 118.

The agentic threat detection and response module 116 integrates with the asset normalization module 110 and the federated log normalization module 112 to access the federated sources (normalized organization data and/or the normalized data log), to effectively orchestrate and execute the threat hunt model. In some aspects, the agentic threat detection and response module 116 may access/obtain the normalized data log associated with the organization infrastructure via the federated log normalization module 112. In some aspects, the agentic threat detection and response module 116 may access/obtain the normalized data log by using a normalized log space 210. Similarly, the agentic threat detection and response module 116 may access/obtain the normalized organization data, via the asset normalization module 110. In some aspects, the agentic threat detection and response module 116 may access/obtain the normalized data log by using a normalized action space 212. The normalized log space 210 and the normalized action space 212 may include tools that may be used by the agentic threat detection and response module 116 to access the normalized data log and the normalized organization data respectively.

In further aspects, the processor 104 may automatically generate one or more threat hunt queries to perform threat hunting in the organization's computing infrastructure based on the structured data. In some aspects, the processor 104 may generate the queries to perform the threat hunting or threat analysis on the normalized data log and/or the normalized organization data. In some aspects, the processor 104 may automatically generate the queries via the agentic threat detection and response module 116. In some aspects, the processor 104 may generate the queries based on organization budget to run the queries. For example, the processor 104 may restrict the query range to a shorter duration, only look for entries related to a specific IP address rather than a range of them, etc. The processor 104 may generate the queries in STIX pattern/format to perform the threat hunting on the normalized data log and/or the normalized organization data. The processor 104 may generate the STIX pattern by using the structured data in STIX 2 format.

The STIX pattern may be composed of multiple building blocks. The building blocks may include a comparison expression, which is a comparison between a single property of a cyber observable object and a given constant using a comparison operator. For instance, the compression expression may be “[ipv4-addr:value=‘x’]”. The building blocks may further include an observation expression which consists of one or more Comparison Expressions joined by Boolean Operators and bound by square brackets. For instance, the observation expression may be “[ipv4-addr: value=‘x’ OR ipv4-addr:value=‘y’]”. The observation expressions may be followed by one or more qualifiers, which allow for the expression of further restrictions on the set of data matching the pattern. The qualifier may include keywords such as “within”, “start/stop”, and “repeats” keywords. For instance, the qualifier may include “within 500 seconds”. Two or more Observation Expressions may be combined by using an observation operator to further constrain the set of observations that match against the pattern expression. For instance, the observation operator may be “and”, “or”, or “followedby”.

Responsive to generating the threat hunt queries, the processor 104 may execute the queries on the normalized data log and/or the normalized organization data via the agentic threat detection and response module 116. In further aspects, the processor 104 may dynamically detect the threat(s) based on the execution of the threat hunt query and perform the action automatically, via the agentic threat detection and response module 116. For instance, the processor 104 may detect the threat when the IP address mentioned in the threat hunt query may be present in the normalized data log. The processor 104 leverages a sophisticated arrangement of the normalized log space 210 and the normalized action space 212 to allow the agentic threat detection and response module 116 (or the second LLM) to dynamically access, analyze, and respond to threats using federated queries, thus eliminating the need for manual data handling and reducing the response times substantially.

In operation, the processor 104 may obtain the threat intelligence feed or the unstructured data from the external source 122. Responsive to obtaining the unstructured data, the processor 104 may convert the structured data into the structured data (or knowledge graph based on STIX format). In some aspects, the processor 104 may determine the relevancy of the unstructured data to the user/organization by using the first LLM, and convert the unstructured data into the structured data when the unstructured data is for the user or the organization. The processor 104 may perform the steps of obtaining the unstructured data, converting the unstructured data into the structured data, and determining the relevancy via the threat intelligence integration module 108.

Responsive to converting the unstructured data to the structured data, the processor 104 may select the threat hunt model, from the plurality of threat hunt models, via the threat hunt orchestrator module 114. The processor 104 may select the threat hunt model based on the structured data. Responsive to selecting the threat hunt model, the processor 104 may trigger and execute, via the threat hunt orchestrator module 114, the selected threat hunt model by using the agentic threat detection and response module 116. As described above, the threat hunt orchestrator module 114 may spin-off a threat hunt orchestrator workflow to enable the agentic threat detection and response module 116 to effectively orchestrate and execute the threat hunting model.

In some aspects, the system 100 may include an agentic workflow memory module 128 and a recommender module 130. The agentic workflow memory module 128 may contain/store the previous actions taken by user using this system. It may further store attributes indicating whether those actions resulted into success or failure. Further, it may store information indicating the cost or other performance features of running the actions. For example, running some queries may be significantly higher than running other queries. The recommender module 130 uses the information from the agentic workflow memory module 128 to suggest next steps in the threat hunting. For example, it may influence the hypothesis generation.

To execute the threat hunt model, the processor 104 may automatically generate the threat hunt queries based on the structured data, via the agentic threat detection and response module 116. As described above, the threat hunt queries may be in STIX pattern or STIX format. The processor 104 may automatically generate the threat hunt queries to perform analysis or threat hunting on the normalized data log and/or the normalized organization data. The processor 104 may access the normalized data log and/or the normalized organization data, via the federated log normalization module 112 and asset normalization module 110, by using the normalized log space 210 and normalized action space 212 respectively.

The processor 104 may then execute the threat hunt model using the normalized data log and/or the normalized organization data. For example, the processor 104 may generate and execute a threat hunt query to confirm if an IP address mentioned in a threat advisory is present in the normalized data log. Based on the execution of the threat hunt model, the processor 104 may dynamically detect the threat by using the agentic threat detection and response module 116, and may automatically perform a mitigation action responsive to detecting the threat, by using the agentic threat detection and response module 116. Thus, the use of the agentic threat detection and response module 116 allows the processor 104 to communicate with the organization data/assets (e.g., the normalized data log and normalized organization data).

In some aspects, the processor 104 may run/execute the threat hunt query in dummy mode to remove any hallucination. For example, the processor 104 may run the query on an emulation environment first. In addition, the processor 104 may automatically ask for permissions to access organization resources and information. Further, the processor 104 may automatically correct for errors in a plan created by the second LLM. For example, if the query compilation phase fails, the processor 104 may generate a new plan by using the failure information.

FIG. 3 depicts a flow diagram of a first method 300 to perform hypothesis-based threat hunting in accordance with the present disclosure. FIG. 3 may be described with continued reference to prior figures. The following process is exemplary and not confined to the steps described hereafter. Moreover, alternative embodiments may include more or less steps than are shown or described herein and may include these steps in a different order than the order described in the following example embodiments.

In some aspects, the processor 104 may perform the method 300. At step 302, the method 300 may include collecting and observing/analyzing the threat intelligence feed (and/or threat events). For example, the processor 104 may determine that a new attack group may be using credential access tactic to target organizations (e.g., the organization described above).

At step 304, the method 300 may include conceiving threat hypothesis. For example, the processor 104 may conceive threat hypothesis that if the attacker were to compromise a user's credentials, the attacker would likely login from a different geo location than the legitimate user. At step 306, the method 300 may include investigating the hypothesis. For example, the processor 104 may search remote login combinations where users would have to travel faster than should be possible, and may remove all events that could be part of a user's normal commute.

At step 308, the method 300 may include checking hypothesis. If the hypothesis is correct, the method 300 may move to step 312. At step 312, the method 300 may include confirming the hypothesis. If the hypothesis is incorrect, the method 300 may move to step 310. At step 310, the method 300 may include revising the hypothesis. The method 300 may then move back to the step 306. At this step 306, the processor 104 may investigate the revised hypothesis.

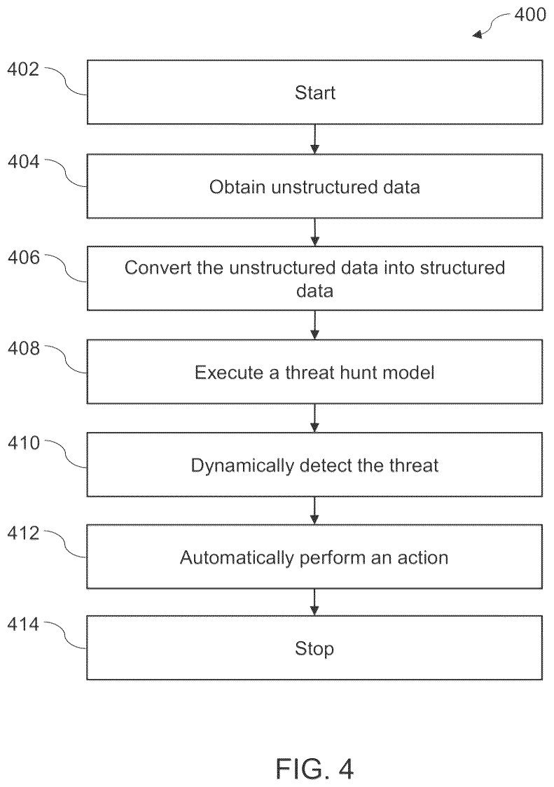

FIG. 4 depicts a flow diagram of a second method 400 to perform threat operations in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include obtaining, via the threat intelligence integration module 108, the unstructured data from one or more external sources 122. At step 406, the method 400 may include converting, via the threat intelligence integration module 108, the unstructured data into a structured data by using a first Large Language Model (LLM).

At step 408, the method 400 may include executing, via a threat hunt orchestrator module 114, a threat hunt model to detect a threat to a computing infrastructure of an organization based on the structured data by using the agentic threat detection and response module 116. As described above, the agentic threat detection and response module 116 may include one or more second LLMs.

At step 410, the method 400 may include dynamically detecting, via the threat hunt orchestrator module 114, the threat based on the execution of the threat hunt model, by using the agentic threat detection and response module 116. At step 412, the method 400 may include automatically performing, via the threat hunt orchestrator module 114, an action responsive to detecting the threat by using the agentic threat detection and response module 116.

At step 414, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a processor; and
a memory storing instructions that, when executed by the processor, cause the processor to:
obtain, via a threat intelligence integration module, an unstructured data having threat content, from one or more external sources;
convert, via the threat intelligence integration module, the unstructured data into a structured data by using a first Large Language Model (LLM);
execute, via a threat hunt orchestrator module, a threat hunt model to detect a presence of a threat to a computing infrastructure of an organization based on the structured data by using an agentic threat detection and response module, wherein the agentic threat detection and response module comprises one or more second LLMs;
dynamically detect, via the threat hunt orchestrator module, the threat based on the execution of the threat hunt model, by using the agentic threat detection and response module; and
automatically perform, via the threat hunt orchestrator module, an action responsive to detecting the threat by using the agentic threat detection and response module.

2. The system of claim 1 further comprising a transceiver configured to receive the unstructured data from the one or more external sources.

3. The system of claim 1, wherein the structured data is in a form of a knowledge graph.

4. The system of claim 3, wherein the knowledge graph is based on a Structured Threat Information eXpression (STIX) format.

5. The system of claim 1, wherein the memory further stores instructions that, when executed by the processor, cause the processor to:
determine, via the threat intelligence integration module, that the threat content is irrelevant for the organization by using the first LLM; and
discard, via the threat intelligence integration module, the unstructured data responsive to a determination that the threat content is irrelevant for the organization.

6. The system of claim 5, wherein the first LLM is trained by using a training dataset that is restricted to a predefined dataset.

7. The system of claim 5, wherein the memory further stores instructions that, when executed by the processor, cause the processor to convert the unstructured data into the structured data responsive to a determination that the threat content is relevant for the organization.

8. The system of claim 1, wherein the memory further stores instructions that, when executed by the processor, cause the processor to:
select, via the threat hunt orchestrator module, the threat hunt model from a plurality of threat hunt models based on the structured data; and
execute, via the threat hunt orchestrator module, the threat hunt model responsive to the selection.

9. The system of claim 8, wherein the plurality of threat hunt models comprises an intel-based hunt model, a predictive hunt model, and a hypothesis-based hunt model.

10. The system of claim 1, wherein the memory further stores instructions that, when executed by the processor, cause the processor to:
obtain, via an asset normalization module, an organization data associated with the computing infrastructure; and
normalize, via the asset normalization module, the organization data to form a normalized organization data.

11. The system of claim 10, wherein the memory further stores instructions that, when executed by the processor, cause the processor to:
obtain, via a federated log normalization module, a data log associated with the computing infrastructure; and
normalize, via the federated log normalization module, the data log to form a normalized data log.

12. The system of claim 11, wherein the normalized data log is associated with one or more of: an Endpoint Detection and Response (EDR) tool, a Security information and event management (SIEM) tool, or a customer specific data.

13. The system of claim 11, wherein the agentic threat detection and response module integrates with the asset normalization module and the federated log normalization module to access the normalized organization data and the normalized data log.

14. The system of claim 13, wherein the memory further stores instructions that, when executed by the processor, cause the processor to:
generate, via the agentic threat detection and response module, a threat hunt query based on the structured data by using the one or more second LLMs, to execute the threat hunt model;
execute, via the agentic threat detection and response module, the threat hunt query on the normalized data log and the normalized organization data; and
dynamically detect, via the agentic threat detection and response module, the threat based on the execution of the threat hunt query.

15. A method comprising:
obtaining, via a threat intelligence integration module, an unstructured data having threat content from one or more external sources;
converting, via the threat intelligence integration module, the unstructured data into a structured data by using a first Large Language Model (LLM);
executing, via a threat hunt orchestrator module, a threat hunt model to detect a presence of a threat to a computing infrastructure of an organization based on the structured data by using an agentic threat detection and response module, wherein the agentic threat detection and response module comprises one or more second LLMs;
dynamically detecting, via the threat hunt orchestrator module, the threat based on the execution of the threat hunt model, by using the agentic threat detection and response module; and
automatically performing, via the threat hunt orchestrator module, an action responsive to detecting the threat by using the agentic threat detection and response module.

16. The method of claim 15, wherein the structured data is in a form of a knowledge graph, and wherein the knowledge graph is based on a Structured Threat Information eXpression (STIX) format.

17. The method of claim 15 further comprising:
selecting, via the threat hunt orchestrator module, the threat hunt model from a plurality of threat hunt models based on the structured data, wherein the plurality of threat hunt models comprises an intel-based hunt model, a predictive hunt model, and a hypothesis-based hunt model; and
executing, via the threat hunt orchestrator module, the threat hunt model responsive to the selection.

18. The method of claim 15 further comprising:
generating, via the agentic threat detection and response module, a threat hunt query based on the structured data by using the one or more second LLMs, to execute the threat hunt model;
executing, via the agentic threat detection and response module, the threat hunt query on a normalized data log and a normalized organization data associated with the computing infrastructure; and
dynamically detecting, via the agentic threat detection and response module, the threat based on the execution of the threat hunt query.

19. The method of claim 18, wherein the normalized data log is associated with one or more of: an Endpoint Detection and Response (EDR) tool, a Security information and event management (SIEM) tool, or a customer specific data.

20. A non-transitory computer-readable storage medium having instructions stored thereupon which, when executed by a processor, cause the processor to:
obtain, via a threat intelligence integration module, an unstructured data having threat content from one or more external sources;
convert, via the threat intelligence integration module, the unstructured data into a structured data by using a first Large Language Model (LLM);
execute, via a threat hunt orchestrator module, a threat hunt model to detect a presence of a threat to a computing infrastructure of an organization based on the structured data by using an agentic threat detection and response module, wherein the agentic threat detection and response module comprises one or more second LLMs;
dynamically detect, via the threat hunt orchestrator module, the threat based on the execution of the threat hunt model, by using the agentic threat detection and response module; and
automatically perform, via the threat hunt orchestrator module, an action responsive to detecting the threat by using the agentic threat detection and response module.
